(19) United States
(12) Patent Application Publication
(10) Pub. No.: US 2022/0005461 A1
(43) Pub. Date: Jan. 6, 2022

(54) METHOD FOR RECOGNIZING A SLOT, AND ELECTRONIC DEVICE

(71) Applicant: BEIJING BAIDU NETCOM SCIENCE AND TECHNOLOGY CO., LTD., Beijing (CN)

(72) Inventors: Lei CHEN, Beijing (CN); Huifeng SUN, Beijing (CN); Shuqi SUN, Beijing (CN); Xinzhe DING, Beijing (CN)

(73) Assignee: BEIJING BAIDU NETCOM SCIENCE AND TECHNOLOGY CO., LTD., Beijing (CN)

(21) Appl. No.: 17/476,183

(22) Filed: Sep. 15, 2021

(30) Foreign Application Priority Data
Dec. 25, 2020 (CN) 202011563106.4

(51) Int. Cl. G10L 15/05; G10L 15/08; G10L 15/18

(52) U.S. Cl. CPC G10L 15/05; G10L 2015/088; G10L 15/1815; G10L 15/083

(57) ABSTRACT

A method for recognizing a slot, and an electronic device are provided. The technical solution includes: determining each first word in an input sentence and a part of speech each first word; combining each first word in the input sentence based on the parts of speech first words in the input sentence based on the part of speech of each first word to obtain one or more candidate slot segments included in the input sentence; determining a matching degree between each first word in the one or more candidate slot segments and each second word in each reference slot of the slot library; and determining a target slot in the one or more candidate slot segments and a slot name of the target slot based on the matching degree.

### CROSS-REFERENCE TO RELATED APPLICATIONS

This application claims the benefit of priority to Chinese Application No. 202011563106.4, filed on Dec. 25, 2020, the contents of which are incorporated herein by reference in their entirety.

### TECHNICAL FIELD

The present disclosure relates to a field of computer technology, specifically involving fields of artificial intelligence technologies such as natural language processing and deep learning, and particularly to a method for recognizing a slot, an electronic device and a storage medium.

### BACKGROUND

With the rise of artificial intelligence technologies and concepts, many products expect to adopt conversational human-computer interaction to enhance product experience. To configure a human-machine dialogue system, it is required to define a dialogue intention and a slot firstly. The dialogue intention refers to a user requirement to be understood by the dialogue system, and the slot refers to key information or a limiting condition when the user's dialogue intention is satisfied, which can be understood as a screening condition that needs to be provided for the user. A generalized recognition technology for various slots is the key to current research.

### SUMMARY

A method and an apparatus for recognizing a slot, and an electronic device are provided in the present disclosure.

According to a first aspect of the present disclosure, there is provided a method for recognizing a slot. The method includes: determining each first word in an input sentence and a part of speech each first word in response to obtaining the input sentence; combining first words in the input sentence based on the part of speech of each first word to obtain one or more candidate slot segments included in the input sentence; querying a preset slot library to determine a matching degree between each first word in the one or more candidate slot segments and each second word in each reference slot of the slot library; and determining a target slot in the one or more candidate slot segments and a slot name of the target slot based on the matching degree between each first word in the one or more candidate slot segments and each second word in each reference slot.

According to a second aspect of the present disclosure, there is provided an electronic device, including: at least one processor; and a memory communicatively coupled to the at least one processor. The memory configured to store instructions executable by the at least one processor. When the instructions are executed by the at least one processor, the at least one professor is configured to execute the method for recognizing a slot in the first aspect of the above embodiments.

According to a third aspect of the present disclosure, there is provided a non-transitory computer-readable storage medium having computer programs stored thereon. The computer instructions are configured to cause a computer to execute the method for recognizing a slot in the first aspect of the above embodiments.

It is understandable that the content in this part is not intended to identify key or important features of the embodiments of the present disclosure, and does not limit the scope of the present disclosure. Other features of the present disclosure will be easily understood through the following specification.

### BRIEF DESCRIPTION OF THE DRAWINGS

The drawings are used to better understand the solution, and are not restrictive of the disclosure, as claimed.

FIG. 1 is a flow chart illustrating a method for recognizing a slot according to an embodiment;

FIG. 2 is a flow chart illustrating a process of constructing a preset slot library according to an embodiment;

FIG. 3 is a flow chart illustrating a process of determining a target slot and a slot name of the target slot according to an embodiment;

FIG. 4 is a flow chart illustrating a process of enriching a preset slot library according to an embodiment;

FIG. 5 is a flow chart illustrating a process of training a synonym model according to an embodiment;

FIG. 6 is a schematic diagram illustrating an apparatus for recognizing a slot according to an embodiment;

FIG. 7 is a block diagram illustrating an electronic device for implementing a method for recognizing a slot according to an embodiment.

### DETAILED DESCRIPTION

The following describes exemplary embodiments of the present disclosure with reference to the attached drawings, which include various details of the embodiments of the present disclosure to facilitate understanding, and they should be considered as merely exemplary. Therefore, those skilled in the art should realize that various changes and modifications can be made to the embodiments described herein without departing from the scope and spirit of the present disclosure. Similarly, for clarity and conciseness, descriptions of well-known functions and structures are omitted in the following description.

AI (Artificial Intelligence) is a discipline that studies computers to simulate certain human thinking processes and intelligent behaviors (such as learning, reasoning, thinking, planning, and the like), relating to both hardware-level technologies and software-level technologies. Artificial intelligence hardware technologies generally include technologies such as sensors, dedicated artificial intelligence chips, cloud computing, distributed storage, and big data processing; while artificial intelligence software technologies mainly include technologies in several directions, such as computer vision technology, speech recognition technology, natural language processing technology and machine learning/deep learning, big data processing technology, and knowledge graph technology.

Deep learning is a new research direction in the field of machine learning, and it is introduced into machine learning to bring it closer to the initial goal-artificial intelligence. With the development of artificial intelligence technologies, more and more methods of using NLP (Natural Language Processing) technology, deep learning technology for error correction in texts emerge. NLP is an important direction in the fields of computer science and artificial intelligence, which studies various theories and methods that can realize effective communication in natural language between human and computers. Deep learning is to learn an inherent law and presentation level of sample data, and information obtained during this learning process is of great help to interpretation of data such as text, images, and sounds. Its ultimate goal is to enable machines to have analytical and learning abilities like human, and to recognize data such as texts, images, and sounds.

With the rise of AI technologies and concepts, many products expect to adopt conversational human-computer interaction to enhance product experience. To configure a human-machine dialogue system, it is required to define a dialogue intention and a slot firstly. The dialogue intention refers to a user requirement to be understood by the dialogue system, and the slot refers to key information or a limiting condition when the user's dialogue intention is satisfied, which can be understood as a screening condition that needs to be provided for the user. Taking the weather checking as an example, when a user asks “the weather of Beijing”, the dialogue intention is “weather checking”, and the slot of the dialogue is “Beijing”, so that the weather of “Beijing” is needed to be provided to the user; when the user asks “the temperature tomorrow”, the dialogue intention is to “temperature checking”, and the slot of the dialogue is “tomorrow”, so that the temperature “tomorrow” is needed to be provided to the user. The generalized recognition for various slots is the key to current research.

In the related arts, after defining a slot, the developer needs to set a large number of slot names. The recognition of the slot depends on the slot name set by the developer, and a main method for setting the slot name is to continuously update a slot library by artificial enrichment. Take the weather checking as an example. The developer needs to collect all the place names and times, as well as their various statements or expressions. For example, if “Haidian District Beijing City” and its synonyms need to be recognized as the same place name, the developer needs to enumerate “Haidian Beijing City”, “Haidian District Beijing”, “Haidian Beijing” and other synonyms for accurate identification. This takes a lot of work for the developer, and it is easy to omit certain statements or expressions, resulting in a low dialogue capability.

To this end, a method and an apparatus for recognizing a slot, and an electronic device are provided in the embodiments of the present disclosure. In the embodiments of the present disclosure, words in an input sentence is combined according to a part of speech of each word in the input sentence to obtain a candidate slot segment included in the input sentence; and a matching degree between a first word in the candidate slot segment and a second word in each reference slot of a slot library is determined; and a target slot included in the candidate slot segment and a slot name of the target slot are determined according to the matching degree, such that not only an accuracy of recognition of the slot is ensured, but also there is no need to configure a large number of slots, thereby reducing the cost for configuring slots, and reducing workload of the developer.

A method and an apparatus for recognizing a slot, an electronic device provided by the embodiments of the present disclosure will be described below with reference to the accompanying drawings.

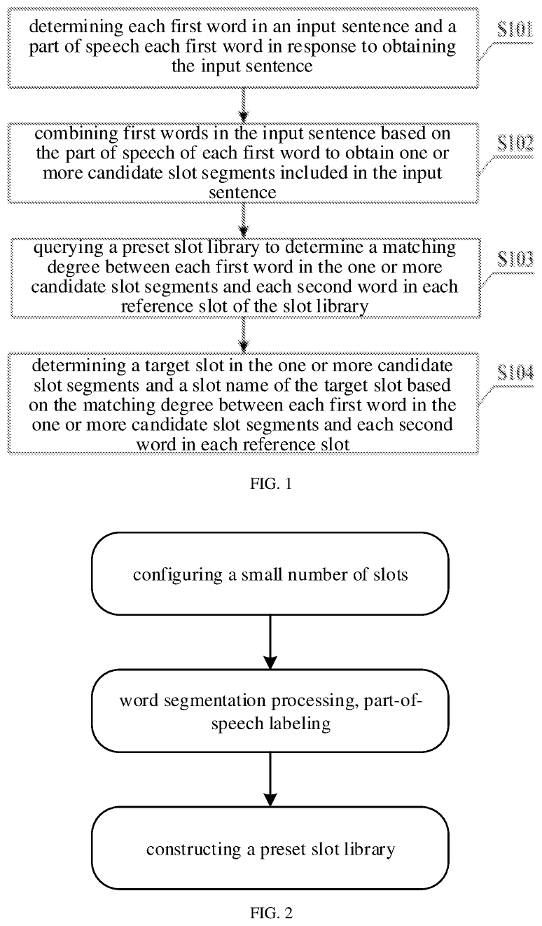

FIG. 1 is a flow chart illustrating a method for recognizing a slot according to an embodiment.

It should be noted that an execution subject of the method for recognizing a slot in the embodiments of the present disclosure may be an electronic device, specifically, the electronic device can be but not limited to a server or a terminal, and the terminal can be but not limited to a personal computer, a smartphone, an IPAD, and the like.

As illustrated in FIG. 1, the method for recognizing a slot includes the following.

In S101, in response to obtaining an input sentence, each first word in the input sentence and a part of speech of each first word are determined.

In the embodiment of the present disclosure, the input sentence may be text information input by a user, or text information obtained by converting voice information input by the user. The input sentence may be a paragraph, and the length and type of the input sentence are not limited. Each word in the input sentence is considered as a first word.

In detail, after the input sentence of the user is obtained, preprocessing such as word segmentation processing and part-of-speech labeling can be used to determine each first word and the part of speech of each word. Understandably, the part of speech relates to a content word (such as noun, verb, adjective, quantifier, pronoun) and a function word (such as preposition, conjunction, auxiliary word, interjection, and onomatopoeia).

For example, in the input sentence “Check the temperature of Haidian Beijing”, the first words include “check”, “temperature”, “Beijing”, and “Haidian”, in which “check” is a verb, “temperature” is a noun, and “Beijing” and “Haidian” are also nouns.

In S102, first words in the input sentence are combined based on the part of speech of each first word to obtain one or more candidate slot segments in the input sentence.

Specifically, after determining each first word included in the input sentence and the part of speech of each first word, in order to facilitate recognition of slots in the input sentence, according to the part of speech of each first word, the first words in the input sentence are combined to obtain one or more candidate slot segments.

For example, the first words “Beijing” and “Haidian” are combined according to the part of speech of noun, and the candidate slot segment obtained by combining is “Haidian Beijing”. It should be noted that the reason why the noun “temperature” is not combined is that “temperature” represents the user's intention rather than a slot of the dialogue.

In the embodiments of the present disclosure, there are many ways to determine the candidate slot segment, and different determining methods may obtain different candidate slot segments, that is, there may be one or more candidate slot segments.

When there is one candidate slot fragment, the candidate slot fragment is a target slot, and a slot name of the candidate slot fragment is a slot name of the target slot. When there are more than one candidate slot fragments, the target slot and its slot name are determined from the more than one candidate slot segments according to S103 and S104 below.

In S103, a preset slot library is queried to determine a matching degree between each first word in the one or more candidate slot segments and each second word in each reference slot of the slot library.

In the embodiments of the present disclosure, as illustrated in FIG. 2, the developer configures a small number of slots in advance. After a server obtains the slots configured by the developer, each slot is preprocessed by word segmentation processing, part-of-speech labeling, and the like, and imported into the slot library, such that the construction of the slot library is realized and the slot library is configured as a basis for subsequent recognition of slots.

The reference slot refers to a slot in the preset slot library, and the second word refers to a word included in the reference slot. The preset slot library includes a plurality of reference slots, and each reference slot includes at least one second word and a part of speech of each second word.

Specifically, after determining the candidate slot segment composed of the first words, according to semantic understanding of the candidate slot segment, the preset slot library is queried to use a heuristic rule to determine the matching degree between each first word in the candidate slot fragment and each second word in each reference slot in the slot library. In other words, assuming that there are n reference slots in the slot library, the matching degree between each first word and each second word in the first reference slot, the matching degree between each first word and each second word in the second reference slot, . . . , and the matching degree between each first word and each second word in the n-th reference slot are determined.

It is understandable that the higher the matching degree is, the higher the similarity between the first word and the second word is. When the matching degree is 0, it means that the first word and the second word are completely dissimilar, the first word does not match the second word; and when the matching degree is 1, the first word matches the second word.

For example, since the similarity between the first word “Beijing” and the second word “Beijing city” is high, the two match; while the first word “Beijing” does not match the second word “Shanghai”.

In S104, a target slot in the one or more candidate slot segments and a slot name of the target slot are determined based on the matching degree between each first word in the one or more candidate slot segments and each second word in each reference slot.

The target slot refers to a slot in the input sentence that needs to be recognized, and the slot name can represent a field to which the slot belongs, a destination of the slot, or a type of the slot. For example, when the target slot is “Haidian Beijing”, the slot name of the target slot is location; when the target slot is “tomorrow”, the slot name of the target slot is time; and when the target slot is “Zhang San”, the slot name of the target slot is person's name.

Specifically, after determining the matching degree between each first word in each candidate slot segment and each second word in each reference slot, a second word that matches a first word and the reference slot containing the second word can be obtained according to the matching degree, and the candidate slot segment is configured as the target slot.

In the embodiment of the present disclosure, the preset slot library may include the slot name of each reference slot. In this case, the slot name of the target slot can be determined according to the slot name of the reference slot. The preset slot library may not include the slot name of each reference slot. In this case, the slot name of the target slot can be determined by analyzing the target slot.

For example, when the user enters the sentence “Check the weather of Haidian Beijing”, according to the parts of speech of “Beijing” and “Haidian”, i.e. noun, they are combined together as the candidate slot segment “Haidian Beijing”, and by querying the preset slot library based on the candidate slot segment, the reference slot “Haidian District Beijing” with the highest matching degree with “Haidian Beijing” is obtained, so that the “Haidian Beijing” can be determined as the target slot, and the slot name of the target slot is place name.

By performing the above operations, when the developer only configures the slot “Haidian District Beijing”, various slots such as “Haidian Beijing”, “Haidian”, “Haidian District” can be recognized, which avoids omission of certain slots and improves recognition ability.

With the method for recognizing a slot in the embodiments of the present disclosure, according to the matching degrees between the words of the candidate slot segments in the input sentence and the words in the slot library, the recognition of slots in the candidate slot segments is performed, such that not only an accuracy of the recognition is ensureed, but also there is no need to configure a large number of slots, which effectively reduces the cost of configuring slots, reduces the workload of the developer, helps the developer to improve the recognition of slots and further enhances the experience of the dialogue system.

When the candidate slot segment is determined based on the part of speech of each first word in S102, the first words which are noun can be combined, or the first words which are noun can be combined according to importance of each word (that is, the first words that are highly important and are noun can be combined), or two first words connected by a conjunction can be combined to obtained the combined candidate slot segment.

In an embodiment of the present disclosure, the above block S102 may include: combining at least two adjacent first words each with the part of speech being noun in the input sentence to generate a candidate slot segment in the input sentence; or, combining two first words adjacent to a first word with the part of speech being conjunction in the input sentence to generate a candidate slot segment in the input sentence.

Specifically, after determining each first word included in the input sentence and the part of speech of each first word, all first words whose part of speech is noun can be obtained, and at least two adjacent first words among them can be obtained. The at least two adjacent first words are combined to generate a candidate slot segment.

For example, when the user enters the sentence “Check the weather in Haidian Beijing”, the nouns “Beijing” and “Haidian” are obtained, and the two nouns are adjacent, so they are combined together as a candidate slot segment “Haidian Beijing”.

Or, after determining each first word included in the input sentence and the part of speech of each first word, the first word B which is noun can be obtained, and the two first words A and C adjacent to the conjunction B can be obtained. The two first words A and C are combined to generate a candidate slot segment.

For example, when the user enters the sentence “Check the weather in Beijing and Shanghai”, the conjunction “and” is obtained, and the two first words “Beijing” and “Shanghai” adjacent to the conjunction are obtained. They are combined together as a candidate slot segment “Beijing Shanghai”.

It should be noted that the candidate slot segment can be determined in any manner in the embodiments of the present disclosure, as long as a reliable candidate slot can be determined, the method of determining the candidate slot segment can be but not limited to the above determining method described in the embodiments of the present disclosure.

Therefore, the candidate slot segment is determined according to the part of speech of each first word, which can ensure the reliability of obtaining the candidate slot segment and improve the efficiency of recognition of slots.

After the candidate slot segment is determined, the matching degree between each first word in the candidate slot segment and each second word in each reference slot in the slot library is determined and the target slot included in the candidate slot segment and the slot name of the target slot are determined according to the matching degree.

The following three embodiments describe how to determine the target slot and the slot name of the target slot according to the matching degree.

In an embodiment of the present disclosure, the above block S104 may include: determining any candidate slot segment as the target slot and a slot name of any reference slot as the slot name of the target slot in a case that each first word in the any candidate slot segment matches a second word in the any reference slot.

In the embodiments of the present disclosure, “any” means “one” instead of “each”.

Specifically, after determining the matching degree between each first word in each candidate slot segment and each second word in each reference slot, when it is determined that first words in one candidate slot segment respectively match the second words in one reference slot in the slot library, the candidate slot segment is determined to be the target slot, and the corresponding slot name is the slot name of the reference slot.

For example, when it is determined that each first word in the candidate slot segment M “Haidian Beijing” matches a second word in the reference slot N “Haidian District Beijing City” (“Beijing” matches “Beijing City”, and “Haidian” matches “Haidian District”), then it is determined that the candidate slot segment M is the target slot, and the corresponding slot name is place name.

In this way, the target slot included in the candidate slot segment and the slot name of the target slot are determined according to the matching degree, so that the developer only needs to configure a small number of slots to recognize various colloquial statements of users and improve the experience of the dialogue system.

In another embodiment of the present disclosure, the above block S104 may include: obtaining a weight value of each second word in the reference slot containing the second word; and determining any candidate slot segment as the target slot and a slot name of any reference slot as the slot name of the target slot in a case that each first word in the any candidate slot segment is included in the any reference slot and the weight value of a second word in the any reference slot but not in the any candidate slot segment is less than a first threshold.

The weight value of the second word in the corresponding reference slot represents an importance of the second word in the corresponding reference slot (that is, function size of the second word), which can be set by the developer according to actual situations, or can be obtained after the execution subject analyzes and processes all the words in the corresponding reference slot. It should be understood that a sum of the weight values of all the second words in the reference slot is 1.

It should be noted that when the weight value is less than the first threshold, it indicates that the second word corresponding to the weight value has a low importance in the reference slot, such that it can be ignored. When the weight value is greater than or equal to the first threshold, it indicates that the second word corresponding to the weight value has a high importance in the reference slot and it should not be ignored.

Specifically, after determining the matching degree between each first word in each candidate slot segment and each second word in each reference slot, the weight value of each second word in the corresponding reference slot can be obtained so as to obtain the importance of each second word in the corresponding reference slot. When it is determined that one reference slot E includes each first word in a candidate slot segment F, a second word in the reference slot E but not in the candidate slot segment F can be obtained; when the weight value of the second word is less than the first threshold, the candidate slot segment F is determined to be the target slot, and the corresponding slot name of the target slot is the slot name of the reference slot E.

For example, if the reference slot E is “Central Road Haidian District Beijing”, and the candidate slot segment F is “Haidian Beijing”, that is, the reference slot E includes each first word “Beijing” and “Haidian” in the candidate slot segment F, then the second word “Central Road” which is in the reference slot E but is not in the candidate slot segment F can be obtained, and the weight value of “Central Road” in the reference slot E can be obtained. When the weight value is less than the first threshold (such as, 0.2), the candidate slot segment F can be determined as the target slot, and the corresponding slot name of the target slot can be place name.

In this way, when the target slot is recognized, the weight values of the second words in the reference slot are considered, so as to avoid the inability to match the slots in the case that the reference slot includes all the words in the candidate slot segment, which will in turn cause a phenomenon that the slot cannot be accurately recognized, thereby improving the accuracy of the recognition.

In another embodiment of the present disclosure, as illustrated in FIG. 3, the above block S104 may include the following.

In S301, at least one associated reference slot is determined for each candidate slot segment based on the matching degree between each first word in each candidate slot segment and each second word in each reference slot.

Specifically, when any first word in a candidate slot segment matches any second word, it is determined that the reference slot containing the any second word is one associated reference slot of the candidate slot segment, and the matching degree between the associated reference slot and the candidate slot segment is greater than 0 and less than or equal to 1. It is understandable that when the matching degree equals to 1, the associated reference slot matches the candidate slot segment (the words and their parts of speech also match).

It should be noted that since there are a plurality of reference slots, and each reference slot includes a plurality of second words, at least one associated reference slot can be determined for a candidate slot segment.

In S302, a weight value of each mismatched first word in each candidate slot segment or a weight value of each mismatched second word in each associated reference slot are respectively determined.

Specifically, a first word in a candidate slot segment but not matching each second word in the at least one associated reference slot of the candidate slot segment is determined (so as to determine each mismatched first word in each candidate slot segment), and the weight value of the first word in the candidate slot segment can be determined. Or, a second word in an associated reference slot of a candidate slot segment but not matching each first word in the candidate slot segment is determined (so as to determine each mismatched second word in each associated reference slot), and the weight value of the second word in the associated reference slot is determined.

In S303, the one or more candidate slot segments and the at least one associated reference slot of each candidate slot segment are filtered based on the weight value of each mismatched first word or the weight value of each mismatched second word to determine the target slot in the one or more candidate slot segments and the slot name of the target slot.

Specifically, the associated reference slot with a lower weight value can be filtered out, so as to determine the target slot in the candidate slot segments and the slot name of the target slot.

For example, the first words in a candidate slot segment include “Haidian Beijing” and “Haidian”. The associated reference slots retrieved according to “Haidian Beijing” include “Haidian District Beijing City” and “Beijing City”, and the associated reference slot retrieved according to “Haidian” includes “Haidian District, Beijing City”. Since the word “Beijing” has a relatively high weight value, the word “Haidian” in the candidate slot segment can be filtered out. Since the word “Haidian” also has a relatively high weight value, the word “Beijing” in the associated reference slots can be filtered out. The target slot included in the candidate slot segment is “Haidian District Beijing City”.

In this way, the candidate slot segments and the associated reference slots are filtered based on the weight value to obtain the target slot, which further improves the accuracy of the recognition.

How to recognize the slot in the user's input sentence based on the preset slot library has been described above. The method can be implemented online by the execution subject. In order to ensure the accuracy of the slot library, the enrichment and expansion of the slot library can be done offline, for example, by manual participation, which not only saves resources, but also ensures accuracy. The following describes how to construct or expand the slot library.

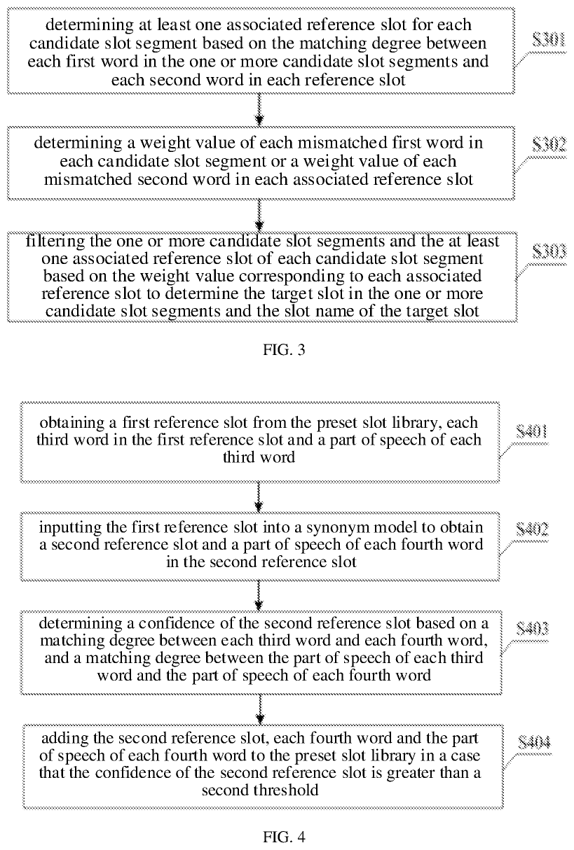

As illustrated in FIG. 4, in an embodiment of the present disclosure, the method for recognizing a slot further includes the following.

In S401, a first reference slot in the preset slot library, each third word in the first reference slot, and the part of speech of each third word can be obtained.

In the embodiment of the present disclosure, each reference slot in the preset slot library can be considered as the first reference slot, and each word in the first reference slot can be considered as the third word. The preset slot library includes a small number of first reference slots (for example, at least one first reference slot).

Specifically, when the recognition of a slot needs to be performed, the first reference slot in the preset slot library, each third word included in the first reference slot, and the part of speech of each third word can be obtained for subsequent use.

In S402, the first reference slot is input into a synonym model to generate a second reference slot and a part of speech of each fourth word in the second reference slot.

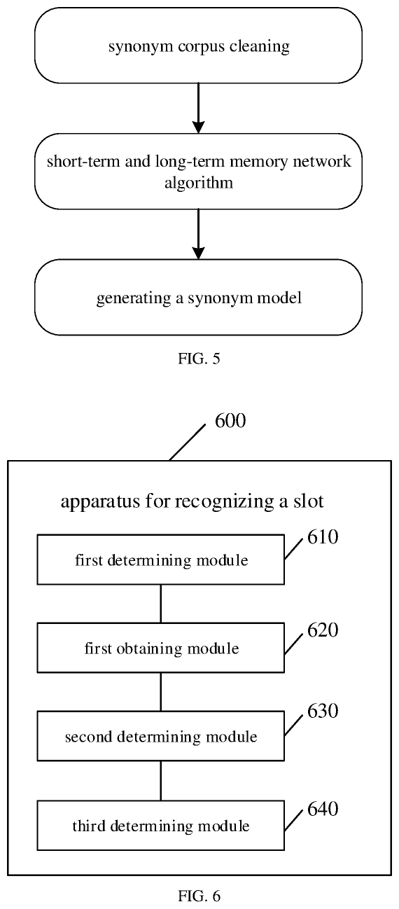

In the embodiment of the present disclosure, the synonym model is pre-trained by the developer. As illustrated in FIG. 5, the training method may include the following: cleaning historical accumulate synonym data to filter out non-Chinese corpus from the data, aligning the remaining data, and ensuring that a length of an input word is greater than or equal to that of a predicted word in the synonym pair; performing training based on the cleaned corpus through a long-term and short-term memory network and an attention mechanism algorithm; obtaining a synonym model after the model converges. The synonym model takes a slot as the input and an abbreviated synonym of the slot as the output.

Specifically, after obtaining the trained synonym model, obtaining the first reference slots from the slot library, and obtaining each third word included in the first reference slots and the part of speech of each third word, all the first reference slots are taken as the input of the model which are input to the synonym model, and the synonym model outputs second reference slots that are synonymous with the first reference slots, such that the second reference slots and the part of speech of each fourth word in the second reference slots are obtained.

It should be noted that, since there is at least one first reference slot, there is also at least one second reference slot that is synonymous with it. The at least one second reference slot is a synonym candidate of the first reference slot.

In S403, a confidence of the second reference slot is determined based on a matching degree between each third word and each fourth word, and a matching degree between the part of speech of each third word and the part of speech of the respective fourth word.

Specifically, after obtaining each third word included in the first reference slot, the part of speech of each third word, and the part of speech of each fourth word in the second reference slot, the matching degree between each third word and each fourth word can be determined. At the same time, the matching degree between the part of speech of each third word and the part of speech of the corresponding fourth word can be determined. According to the matching degrees, the confidence of the second reference slot can be determined.

The confidence refers to a degree of reliability, which can also be called a degree of credibility. The higher the matching degree is, the higher the confidence is. When the matching degree is 1 (i.e. matching), the confidence is 1.

In S404, the second reference slot, each fourth word and the part of speech of each fourth word are added to the preset slot library in a case that the confidence of the second reference slot is greater than a second threshold.

Specifically, after obtaining the confidence of the second reference slot, the size of the confidence is determined. When the confidence is greater than the second threshold, it means that the second reference slot output by the model is reliable, so the second reference slot, each fourth word and the part of speech of each fourth word are added to the preset slot library to realize enrichment of the slot library.

It is understandable that when the confidence of the second reference slot is less than or equal to the second threshold, it means that important component of the inputted first reference slot is lost in the output result, that is, the second reference slot is unreliable, and the second reference slot is filtered out.

That is, after the developer configures a small number of slots, these slots are configured as the input of model which are input into the synonym model, and the output of the model is obtained. The output of the model is considered as the synonym candidates which are filtered to obtain the synonyms of the slots configured by the developer, and the synonyms are added to the preset slot library to realize enrichment of the slot library.

For example, when the developer configures “Haidian District, Beijing Cith” and inputs it into the synonym model, the synonym model may output “Haidian Beijing”, “Haidian District, Beijing”, or “Zhongguancun Beijing”. The developer can select the required slots to add to the slot library as needed to reduce the cost of enrichment.

Thus, model recommendation can effectively save the cost of the developer for enriching reference slots, improve the recognition ability of the dialogue system, and further improve the accuracy of the model, so as to reduce the cost of enrichment.

There is also provided an apparatus for recognizing a slot in an embodiment of the present disclosure. FIG. 6 is a block diagram illustrating an apparatus for recognizing a slot provided by embodiments of the present disclosure.

As illustrated in FIG. 6, the apparatus 600 for recognizing a slot includes a first determining module 610, a first obtaining module 620, a second determining module 630 and a third determining module 640.

The first determining module 610 is configured to determine each first word an input sentence and a part of speech each first word in response to obtaining the input sentence. The first obtaining module 620 is configured to combine first words in the input sentence based on the part of speech of each first word to obtain one or more candidate slot segments included in the input sentence. The second determining module 630 is configured to query a preset slot library to determine a matching degree between each first word in the one or more candidate slot segments and each second word in each reference slot of the slot library. The third determining module 640 is configured to determine a target slot in the one or more candidate slot segments and a slot name of the target slot based on the matching degree between each first word in the one or more candidate slot segments and each second word in each reference slot.

In an embodiment of the present disclosure, the third determining module 640 may include a first determining unit. The first determining unit is configured to determine any candidate slot segment as the target slot and a slot name of any reference slot as the slot name of the target slot in a case that each first word in the any candidate slot segment matches a second word in the any reference slot.

In another embodiment of the present disclosure, the third determining module 640 may include a first obtaining unit and a second determining unit. The first obtaining unit is configured to obtain a weight value of each second word in the reference slot containing the second word. The second determining unit is configured to determine any candidate slot segment as the target slot and a slot name of any reference slot as the slot name of the target slot in a case that each first word in the any candidate slot segment is included in the any reference slot and the weight value of a second word in the any reference slot but not in the any candidate slot segment is less than a first threshold.

In an embodiment of the present disclosure, the third determining module 640 may include a third determining unit, a fourth determining unit, and a fifth determining unit. The third determining unit is configured to determine at least one associated reference slot for each candidate slot segment based on the matching degree between each first word in the one or more candidate slot segments and each second word in each reference slot. The fourth determining unit is configured to determine a weight value of each mismatched first word in each candidate slot segment or a weight value of each mismatched second word in each associated reference slot. The fifth determining unit is configured to filter the one or more candidate slot segments and the at least one associated reference slot of each candidate slot segment based on the weight value corresponding to each associated reference slot to determine the target slot in the one or more candidate slot segments and the slot name of the target slot.

In an embodiment of the present disclosure, the apparatus for recognizing a slot further includes a second obtaining module, a first generating module, fourth determining module, and a first adding module. The second obtaining module is configured to obtain a first reference slot from the preset slot library, each third word in the first reference slot and a part of speech of each third word. The first generating module is configured to input the first reference slot into a synonym model to obtain a second reference slot and a part of speech of each fourth word in the second reference slot. The fourth determining module is configured to determine a confidence of the second reference slot based on a matching degree between each third word and each fourth word, and a matching degree between the part of speech of each third word and the part of speech of each fourth word. The first adding module is configured to add the second reference slot, each fourth word and the part of speech of each fourth word to the preset slot library in a case that the confidence of the second reference slot is greater than a second threshold.

It is to be noted that other specific implementations of the apparatus for recognizing a slot in the embodiments of the present disclosure can refer to the specific implementation of the method for recognizing a slot in the foregoing embodiments, which will not be elaborated here to avoid redundancy.

With the apparatus for recognizing a slot in the embodiments of the present disclosure, according to the matching degrees between the words of the candidate slot segments in the input sentence and the words in the slot library, the recognition of slots in the candidate slot segments is performed, such that not only an accuracy of the recognition is ensureed, but also there is no need to configure a large number of slots, which effectively reduces the cost of configuring slots, reduces the workload of the developer.

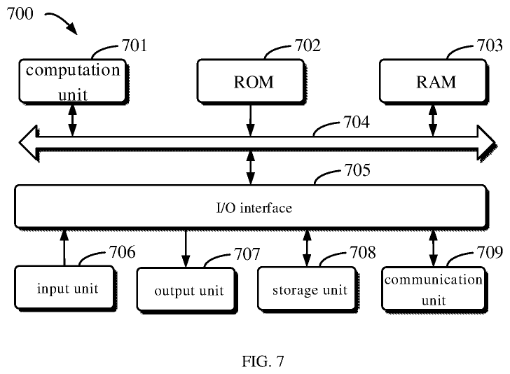

According to the embodiments of the present disclosure, there is provided an electronic device, a readable-storage medium and a computer program product for recognizing a slot, which will be illustrated in combination with FIG. 7.

As illustrated in FIG. 7, it is a block diagram illustrating an electronic device for implementing a method for recognizing a slot according to an embodiment of the present disclosure. Electronic devices are intended to represent various forms of digital computers, such as laptop computers, desktop computers, work tables, personal digital assistants, servers, blade servers, mainframe computers, and other suitable computers. Electronic devices can also represent various forms of mobile apparatus, such as personal digital processors, cellular phones, smart phones, wearable devices, and other similar computing apparatus. The components illustrated herein, their connections and relationships, and their functions are merely examples, and are not intended to limit the implementation of the disclosure described and/or required herein.

As illustrated in FIG. 7, the device 700 includes a calculation unit 701, which can execute various appropriate actions and processing according to the computer program stored in a read only memory (ROM) 702 or the computer program loaded in a random access memory (RAM) 703 from the storage unit 708. In the RAM 703, various programs and data required for the operation of the storage device 700 are also stored. The calculation unit 701, the ROM 112, and the RAM 703 are connected to each other through a bus 704. An input/output (I/O) interface 705 is also connected to the bus 704. A plurality of components in the device 700 are connected to the I/O interface 705, including: an input unit 706, such as a keyboard, a mouse, and the like; an output unit 707, such as various types of displays, speakers, and the like; and a storage unit 708, such as a magnetic disk, an optical disk, and the like; and a communication unit 709, such as a network card, a modem, a wireless communication transceiver, and the like. The communication unit 709 allows the device 700 to exchange information/data with other devices through a computer network such as the Internet and/or various telecommunication networks.

The computation unit 701 may be various general-purpose and/or special-purpose processing components with processing and computing capabilities. Some examples of the computation unit 701 include but are not limited to central processing unit (CPU), graphics processing unit (GPU), various dedicated artificial intelligence (AI) computing chips, various computing units running machine learning model algorithms, digital signal processor (DSP), and any appropriate processor, controller, micro-controller, and the like. The calculation unit 701 executes each method and processing described above, such as the method for recognizing a slot. For example, in some embodiments, the method for recognizing a slot can be implemented as a computer software program, which is tangibly included in a machine-readable medium, such as the storage unit 708. In some embodiments, part or all of the computer program may be loaded and/or installed on the device 700 via the ROM 702 and/or the communication unit 709. When the computer program is loaded into the RAM 703 and executed by the calculation unit 701, one or more blocks of the method for recognizing a slot described above can be executed. Optionally, in other embodiments, the calculation unit 701 may be configured to implement a method for recognizing a slot by any other suitable means (for example, by firmware).

Various implementations of the systems and technologies described herein can be implemented in digital electronic circuit systems, integrated circuit systems, field programmable gate arrays (FPGA), application specific integrated circuits (ASIC), application-specific standard products (ASSP), systems on chip (SOC), complex programmable logic device (CPLD), computer hardware, firmware, software, and/or their combination thereof. These various embodiments may be executed in one or more computer programs, in which the one or more computer programs may be executed and/or interpreted on a programmable system including at least one programmable processor, in which the programmable processor may be a dedicated or general-purpose programmable processor that can receive data and instructions from the storage system, at least one input apparatus, and at least one output apparatus, and transmit the data and instructions to the storage system, at least one input apparatus, and at least one output apparatus.

The program codes used to implement the method of the present disclosure can be written in any combination of one or more programming languages. These program codes can be provided to processors or controllers of general-purpose computers, special-purpose computers, or other programmable data processing apparatus, so that when the program codes are executed by a processor or a controller, functions/operations specified in flowcharts and/or block diagrams are implemented. The program codes can be entirely executed on a machine, partly executed on a machine, partly executed on a machine as an independent software package and partly executed on a remote machine or entirely executed on a remote machine or a server.

In the context of the present disclosure, a machine-readable medium may be a tangible medium, which may include or store programs for use by instruction execution systems, apparatus, or devices, or for use by the combination of instruction execution systems, apparatus, or devices. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with the user, the systems and technologies described herein can be executed on a computer and the computer includes a display apparatus for displaying information to the user (for example, a CRT (cathode ray tube) or an LCD (liquid crystal display) monitor)); and a keyboard and a pointing apparatus (for example, a mouse or a trackball) through which the user can provide input to the computer. Other types of apparatus can also be used to provide interaction with the user; for example, the feedback provided to the user can be any form of sensory feedback (for example, visual feedback, auditory feedback, or tactile feedback); and can be in any form (including acoustic input, voice input, or tactile input) to receive input from the user.

The systems and technologies described herein can be executed in a computing system that includes back-end components (for example, as a data server), or a computing system that includes middleware components (for example, an application server), or a computing system that includes front-end components (for example, a user computer with a graphical user interface or web browser through which the user can interact with the implementation of the systems and technologies described herein), or a computing system that includes any combination of the back-end components, middleware components, or front-end components. The components of the system can be connected to each other through any form or medium of digital data communication (for example, a communication network). Examples of communication networks include: a local area network (LAN), a wide area network (WAN), the Internet, and a blockchain network.

The computer system may include a client and a server. The client and server are generally far away from each other and usually interact through a communication network. The relationship between the client and the server is generated by computer programs that run on the corresponding computer and have a client-server relationship with each other. The server can be a cloud server, also known as a cloud computing server or a cloud host, which is a host product in the cloud computing service system to solve the problem of difficult management and weak business scalability of traditional physical hosts and VPS (Virtual Private Server) services. The server can also be the server for distributed system, or the server that combine block chain.

According to the technical solution of the embodiments of the present disclosure, according to the matching degrees between the words of the candidate slot segments in the input sentence and the words in the slot library, the recognition of slots in the candidate slot segments is performed, such that not only an accuracy of the recognition is ensureed, but also there is no need to configure a large number of slots, which effectively reduces the cost of configuring slots, reduces the workload of the developer.

In the description of the present disclosure, the terms “first” and “second” are only used to describe purposes, and cannot be understood as indicating or implying relative importance or implicitly indicating the number of indicated technical features. Therefore, the features defined with “first” and “second” may explicitly or implicitly include at least one of the features. In the description of the present disclosure, “a plurality of” means at least two, such as two, three, and the like, unless otherwise specified.

It is understandable that the various forms of processes illustrated above can be used to reorder, add or delete blocks. For example, the blocks described in the present disclosure can be executed in parallel, sequentially, or in a different order, as long as the desired result of the technical solution disclosed in the present disclosure can be achieved, this is not limited herein.

The above specific implementations do not constitute a limitation on the protection scope of the present disclosure. Those skilled in the art should understand that various modifications, combinations, sub-combinations and substitutions can be made according to design requirements and other factors. Any modification, equivalent replacement and improvement made within the spirit and principle of the disclosure shall be included in the protection scope of this disclosure.

What is claimed is:

1. A method for recognizing a slot, comprising:
determining each first word in an input sentence and a part of speech each first word in response to obtaining the input sentence;
combining first words in the input sentence based on the part of speech of each first word to obtain one or more candidate slot segments included in the input sentence;
querying a preset slot library to determine a matching degree between each first word in the one or more candidate slot segments and each second word in each reference slot of the slot library; and
determining a target slot in the one or more candidate slot segments and a slot name of the target slot based on the matching degree between each first word in the one or more candidate slot segments and each second word in each reference slot.

2. The method of claim 1, wherein combining first words in the input sentence based on the part of speech of each first word to obtain one or more candidate slot segments included in the input sentence comprises one of the following:
combining at least two adjacent first words each with the part of speech being noun in the input sentence to generate a candidate slot segment in the input sentence;
and,
combining two first words adjacent to a first word with the part of speech being conjunction in the input sentence to generate a candidate slot segment in the input sentence.

3. The method of claim 1, wherein determining a target slot in the one or more candidate slot segments and a slot name of the target slot based on the matching degree between each first word in the one or more candidate slot segments and each second word in each reference slot comprises:
determining any candidate slot segment as the target slot and a slot name of any reference slot as the slot name of the target slot in a case that each first word in the any candidate slot segment matches a second word in the any reference slot.

4. The method of claim 1, wherein determining a target slot in the one or more candidate slot segments and a slot name of the target slot based on the matching degree between each first word in the one or more candidate slot segments and the second words in each reference slot comprises:
obtaining a weight value of each second word in the reference slot containing the second word; and
determining any candidate slot segment as the target slot and a slot name of any reference slot as the slot name of the target slot in a case that each first word in the any candidate slot segment is included in the any reference slot and the weight value of a second word in the any reference slot but not in the any candidate slot segment is less than a first threshold.

5. The method of claim 1, wherein determining a target slot in the one or more candidate slot segments and a slot name of the target slot based on the matching degree between each first word in the one or more candidate slot segments and each second word in each reference slot comprises:
determining at least one associated reference slot for each candidate slot segment based on the matching degree between each first word in the one or more candidate slot segments and each second word in each reference slot;
determining a weight value of each mismatched first word in each candidate slot segment or a weight value of each mismatched second word in each associated reference slot; and
filtering the one or more candidate slot segments and the at least one associated reference slot of each candidate slot segment based on the weight value of each mismatched first word in each candidate slot segment or the weight value of each mismatched second word in each associated reference slot to determine the target slot in the one or more candidate slot segments and the slot name of the target slot.

6. The method of claim 1, further comprising:
obtaining a first reference slot from the preset slot library, each third word in the first reference slot and a part of speech of each third word;
inputting the first reference slot into a synonym model to obtain a second reference slot and a part of speech of each fourth word in the second reference slot;
determining a confidence of the second reference slot based on a matching degree between each third word and each fourth word, and a matching degree between the part of speech of each third word and the part of speech of each fourth word; and
adding the second reference slot, each fourth word and the part of speech of each fourth word to the preset slot library in a case that the confidence of the second reference slot is greater than a second threshold.

7. An electronic device, comprising:
at least one processor; and
a memory communicatively coupled to the at least one processor;
wherein the memory is configured to store instructions executable by the at least one processor, wherein when the instructions are executed by the at least one processor, the at least one processor is configured to execute the method for recognizing a slot, comprising:
determining each first word in an input sentence and a part of speech each first word in response to obtaining the input sentence;
combining first words in the input sentence based on the part of speech of each first word to obtain one or more candidate slot segments included in the input sentence;
querying a preset slot library to determine a matching degree between each first word in the one or more candidate slot segments and each second word in each reference slot of the slot library; and
determining a target slot in the one or more candidate slot segments and a slot name of the target slot based on the matching degree between each first word in the one or more candidate slot segments and each second word in each reference slot.

8. The device of claim 7, wherein combining first words in the input sentence based on the part of speech of each first word to obtain one or more candidate slot segments included in the input sentence comprises one of the following:
combining at least two adjacent first words each with the part of speech being noun in the input sentence to generate a candidate slot segment in the input sentence;
and,
combining two first words adjacent to a first word with the part of speech being conjunction in the input sentence to generate a candidate slot segment in the input sentence.

9. The device of claim 7, wherein determining a target slot in the one or more candidate slot segments and a slot name of the target slot based on the matching degree between each first word in the one or more candidate slot segments and each second word in each reference slot comprises:
determining any candidate slot segment as the target slot and a slot name of any reference slot as the slot name of the target slot in a case that each first word in the any candidate slot segment matches a second word in the any reference slot.

10. The device of claim 7, wherein determining a target slot in the one or more candidate slot segments and a slot name of the target slot based on the matching degree between each first word in the one or more candidate slot segments and the second words in each reference slot comprises:
obtaining a weight value of each second word in the reference slot containing the second word; and
determining any candidate slot segment as the target slot and a slot name of any reference slot as the slot name of the target slot in a case that each first word in the any candidate slot segment is included in the any reference slot and the weight value of a second word in the any reference slot but not in the any candidate slot segment is less than a first threshold.

11. The device of claim 7, wherein determining a target slot in the one or more candidate slot segments and a slot name of the target slot based on the matching degree between each first word in the one or more candidate slot segments and each second word in each reference slot comprises:
determining at least one associated reference slot for each candidate slot segment based on the matching degree between each first word in the one or more candidate slot segments and each second word in each reference slot;
determining a weight value of each mismatched first word in each candidate slot segment or a weight value of each mismatched second word in each associated reference slot; and
filtering the one or more candidate slot segments and the at least one associated reference slot of each candidate slot segment based on the weight value of each mismatched first word or the weight value of each mismatched second word to determine the target slot in the one or more candidate slot segments and the slot name of the target slot.

12. The device of claim 7, wherein the at least one processor is further configured to perform:
obtaining a first reference slot from the preset slot library, each third word in the first reference slot and a part of speech of each third word;
inputting the first reference slot into a synonym model to obtain a second reference slot and a part of speech of each fourth word in the second reference slot;
determining a confidence of the second reference slot based on a matching degree between each third word and each fourth word, and a matching degree between the part of speech of each third word and the part of speech of each fourth word; and
adding the second reference slot, each fourth word and the part of speech of each fourth word to the preset slot library in a case that the confidence of the second reference slot is greater than a second threshold.

13. A non-transitory computer-readable storage medium having computer instructions stored thereon, wherein the computer instructions are configured to cause a computer to execute the method for recognizing a slot, comprising:
determining each first word in an input sentence and a part of speech each first word in response to obtaining the input sentence;
combining first words in the input sentence based on the part of speech of each first word to obtain one or more candidate slot segments included in the input sentence;
querying a preset slot library to determine a matching degree between each first word in the one or more candidate slot segments and each second word in each reference slot of the slot library; and
determining a target slot in the one or more candidate slot segments and a slot name of the target slot based on the matching degree between each first word in the one or more candidate slot segments and each second word in each reference slot.

14. The storage medium of claim 13, wherein combining first words in the input sentence based on the part of speech of each first word to obtain one or more candidate slot segments included in the input sentence comprises one of the following:
combining at least two adjacent first words each with the part of speech being noun in the input sentence to generate a candidate slot segment in the input sentence;
and,
combining two first words adjacent to a first word with the part of speech being conjunction in the input sentence to generate a candidate slot segment in the input sentence.

15. The storage medium of claim 13, wherein determining a target slot in the one or more candidate slot segments and a slot name of the target slot based on the matching degree between each first word in the one or more candidate slot segments and each second word in each reference slot comprises:
determining any candidate slot segment as the target slot and a slot name of any reference slot as the slot name of the target slot in a case that each first word in the any candidate slot segment matches a second word in the any reference slot.

16. The storage medium of claim 13, wherein determining a target slot in the one or more candidate slot segments and a slot name of the target slot based on the matching degree between each first word in the one or more candidate slot segments and the second words in each reference slot comprises:
obtaining a weight value of each second word in the reference slot containing the second word; and
determining any candidate slot segment as the target slot and a slot name of any reference slot as the slot name of the target slot in a case that each first word in the any candidate slot segment is included in the any reference slot and the weight value of a second word in the any reference slot but not in the any candidate slot segment is less than a first threshold.

17. The storage medium of claim 13, wherein determining a target slot in the one or more candidate slot segments and a slot name of the target slot based on the matching degree between each first word in the one or more candidate slot segments and each second word in each reference slot comprises:
determining at least one associated reference slot for each candidate slot segment based on the matching degree between each first word in the one or more candidate slot segments and each second word in each reference slot;
determining a weight value of each mismatched first word in each candidate slot segment or a weight value of each mismatched second word in each associated reference slot; and
filtering the one or more candidate slot segments and the at least one associated reference slot of each candidate slot segment based on the weight value of each mismatched first word or the weight value of each mismatched second word to determine the target slot in the one or more candidate slot segments and the slot name of the target slot.

18. The storage medium of claim 13, wherein the at least one processor is further configured to perform:
obtaining a first reference slot from the preset slot library, each third word in the first reference slot and a part of speech of each third word;
inputting the first reference slot into a synonym model to obtain a second reference slot and a part of speech of each fourth word in the second reference slot;
determining a confidence of the second reference slot based on a matching degree between each third word and each fourth word, and a matching degree between the part of speech of each third word and the part of speech of each fourth word; and
adding the second reference slot, each fourth word and the part of speech of each fourth word to the preset slot library in a case that the confidence of the second reference slot is greater than a second threshold.
